(19) United States
(12) Patent Application Publication
(10) Pub. No.: US 2024/0422441 A1
(43) Pub. Date: Dec. 19, 2024

(54) Apparatus and Method for Inspecting Containers

(71) Applicant: Thomas Huhn, München (DE)

(72) Inventor: Thomas Huhn, München (DE)

(73) Assignee: Emhart Glass SA, Steinhausen (CH)

(21) Appl. No.: 18/821,261

(22) Filed: Aug. 30, 2024

Related U.S. Application Data
(63) Continuation of application No. PCT/EP2023/054938, filed on Feb. 28, 2023.

(30) Foreign Application Priority Data
Mar. 3, 2022 (DE) 10 2022 104 990.6

(51) Int. Cl. H04N 23/74; H04N 23/56; H04N 23/90

(52) U.S. Cl. CPC H04N 23/74; H04N 23/56; H04N 23/90

(57) ABSTRACT

The apparatus for inspecting containers comprises an illumination device, a rotation device and a capturing device. The illumination device is configured to illuminate an illumination region alternately with different illumination patterns, which comprise at least a first illumination pattern and a second illumination pattern. The illumination device is configured to illuminate the illumination region with the first illumination pattern in first time windows and to illuminate it with the second illumination pattern in second time windows. The rotation device is configured to rotate a container with a bottom and with a sidewall about an axis of the container in such a way that at least a section of the sidewall passes through the illumination region along a rotational direction. The capturing device is configured to take a photo of the illumination region at least in each first time window and in each second time window.

### CROSS-REFERENCE TO RELATED PATENT APPLICATIONS

This patent application is a continuation of co-pending PCT Patent Application No. PCT/EP2023/054938, filed Feb. 28, 2023, which is now pending, and which claims the benefit of German patent application DE 10 2022 104 990.6, filed Mar. 3, 2022, the entire teachings and disclosure each of which are incorporated herein by reference thereto.

### FIELD OF THE INVENTION

The invention relates to the inspection of containers, in particular the inspection of transparent or translucent containers.

### BACKGROUND OF THE INVENTION

From EP 2 434 276 B1, an inspection method for checking transparent or translucent containers for defects such as cracks, fissures, bubbles or the like is known. The containers are continuously conveyed along a conveying direction by a conveying device. Each container passes through an inspection station in which a non-contact inspection of at least one selected container region of each container takes place. The container is temporarily raised or lowered substantially perpendicular to the conveying direction. During the raising or lowering of a container, the selected container region is irradiated by at least two radiation sources arranged on opposite sides of the container. The radiation reflected by the raised or lowered container is captured by at least one capturing device with a sensor unit assigned to each radiation source. In order to prevent, for example, opposite radiation sources from negatively influencing each other when a fault is detected, sequential all-round scanning occurs.

The system of EP 2 434 276 B1 is comparatively complex and requires a large number of components.

### BRIEF SUMMARY OF THE INVENTION

The object of the invention is to provide a way in which containers may be inspected with the least possible effort and yet with a high inspection quality.

This object is solved in each case by the apparatus according to claim 1 or the method according to claim 12. The dependent claims indicate advantageous embodiments of the invention.

According to an aspect of the invention, an apparatus for inspecting containers is provided. The apparatus comprises an illumination device, a rotation device and a capturing device. The illumination device is configured to alternately illuminate an illumination region with different illumination patterns. The different illumination patterns comprise at least a first illumination pattern and a second illumination pattern. The illumination device is configured to illuminate the illumination region with the first illumination pattern in first time windows and to illuminate it with the second illumination pattern in second time windows. The rotation device is configured to rotate a container with a bottom and with a sidewall about an axis of the container in such a way that at least a section of the sidewall passes through the illumination region along a rotational direction. The capturing device is configured to take a photo of the illumination region at least in every first time window and in every second time window.

Since the section of the sidewall of the container passes through the illumination region along the rotational direction, a region of the sidewall may be inspected within the illumination region which has a greater extension along the rotational direction than the extension of the illumination region along the rotational direction. In particular, a region of the sidewall that extends around a full circumference of the container may be inspected within the illumination region. It is not necessary to arrange inspection units on different sides of the container.

Due to the illumination of the illumination region by the illumination device, flaws and defects in the sidewall may be more easily recognizable compared to an unlit state.

Depending on the illumination pattern with which the sidewall is illuminated in the illumination region, different types of flaws or defects in the sidewall may be visible to different degrees. In the first time windows, in which the illumination region is illuminated with the first illumination pattern, a different type of flaw or defect in a region of the sidewall located in the illumination region may be particularly well recognizable than in the second time windows, in which the illumination region is illuminated with the second illumination pattern.

Since the capturing device takes a photo of the illumination region in every first time window and in every second time window, photos are obtained in which the sidewall is illuminated with the first illumination pattern as well as photos in which the sidewall is illuminated with the second illumination pattern.

Due to the alternation between at least the first illumination pattern and the second illumination pattern, a photo with the first illumination pattern and a photo with the second illumination pattern may be taken when the container is rotated further by a certain angle of rotation. The frequency of an alternation between the first illumination pattern and the second illumination pattern may be suitably adapted to a rotational speed of the container in order to achieve a desired resolution along the circumference of the sidewall. The frequency of alternation between at least the first illumination pattern and the second illumination pattern may be suitably adapted to the rotational speed of the container in order to completely cover a region of the sidewall extending around a full circumference of the container with photos captured with the first illumination pattern and with photos captured with the second illumination pattern in the course of a full rotation of the container. A region of the sidewall of the container that extends around a full circumference of the container may be completely inspected with the first illumination pattern and with the second illumination pattern within one rotation.

Since the illumination with the first illumination pattern and the illumination with the second illumination pattern, as well as the corresponding photos, occur in the same illumination region, a viewing window onto the container may be substantially fully utilized both for photos with the first illumination pattern and for photos with the second illumination pattern. A viewing window onto the container can, for example, be limited by devices for transporting the container, by neighboring containers or by other machine elements.

Since the illumination with the first illumination pattern and the illumination with the second illumination pattern as well as the corresponding photos occur one after the other, mutual interference between the different illumination patterns may be reduced or avoided.

The sidewall of the container may be transparent or translucent. The sidewall of the container may comprise glass or be made of glass. The sidewall of the container may comprise or consist of, for example, white glass, amber glass, green glass, blue glass, red glass or otherwise colored glass, in particular in the visible spectrum. The sidewall may comprise or consist of black glass. Black glass refers to glass that is opaque in the visible wavelength range, but may allow a certain transmission in the NIR range (near-infrared range), in particular in the range between 760 nanometers and 2500 nanometers.

The axis of the container may be perpendicular to the bottom of the container. The axis of the container may extend along a direction that is parallel to the direction in which the sidewall extends away from the bottom. During rotation by the rotation device, the container may be on a horizontal plane. During rotation by the rotation device, the container, in particular the bottom of the container, may stand on a horizontal surface. During rotation by the rotation device, the axis of the container may run along a vertical direction. The rotational direction may correspond to a circumferential direction of the sidewall.

The container may be formed as a bottle, in particular as a glass bottle. The container may be formed as a canning jar or as a non-circular container. The container may be formed as a packaging jar.

Preferably, the illumination device is configured to periodically alternately illuminate the illumination region with the different illumination patterns. A periodicity of the illumination sequence may simplify synchronization between the illumination device and the capturing device.

The different illumination patterns may comprise only the first illumination pattern and the second illumination pattern. The different illumination patterns may include one or more further illumination patterns, in particular at least a third illumination pattern.

Preferably, a second time window directly follows a preceding first time window. Preferably, a first time window directly follows a preceding second time window. If the illumination with the first illumination pattern and the illumination with the second illumination pattern directly follow one another in time, the container may be inspected comparatively quickly, so that a high throughput of containers may be achieved. A time span between illuminating the illumination region with the first illumination pattern and subsequently illuminating the illumination region with the second illumination pattern may be less than 200 microseconds, or less than 150 microseconds, or less than 100 microseconds, or less than 50 microseconds, or less than 30 microseconds, or less than 20 microseconds. A time interval between an illumination of the illumination region with the second illumination pattern and a subsequent illumination of the illumination region with the first illumination pattern may be less than 200 microseconds, or less than 150 microseconds, or less than 100 microseconds, or less than 50 microseconds, or less than 30 microseconds, or less than 20 microseconds.

There may be a time interval between a first time window and a second time window following it. There may be a time interval between a second time window and a first time window following it. In particular, at least a third time window may lie between a first time window and a subsequent second time window or between a second time window and a subsequent first time window. In the third time window, the illumination region may be unlit or illuminated with a third illumination pattern. The capturing device may be configured to take a photo of the illumination region in the third time window.

In the first time window, the illumination region may be continuously illuminated with the first illumination pattern. In the second time window, the illumination region may be continuously illuminated with the second illumination pattern. The first time window may have a time duration of less than 200 microseconds, or a time duration of less than 100 microseconds, or a time duration of less than 50 microseconds, or a time duration of less than 20 microseconds. The second time window may have a time duration of less than 200 microseconds, or a time duration of less than 100 microseconds, or a time duration of less than 50 microseconds, or a time duration of less than 20 microseconds. The first time window may have a time duration of more than 10 microseconds, or more than 50 microseconds. The second time window may have a time duration of more than 10 microseconds, or more than 50 microseconds. All first time windows may have the same time duration. All second time windows may have the same time duration. A time duration of the first time window and a time duration of the second time window may at least substantially coincide, for example up to at most 20 percent, or up to at most 10 percent, or up to at most 5 percent of the larger time window.

The rotation device may be configured to rotate the container continuously, in particular at a constant angular speed. The rotation device may be configured to rotate the container intermittently.

The first illumination pattern may correspond to an at least substantially uniform illumination of the illumination region. An at least substantially uniform illumination of the illumination region may facilitate the detection of opaque defects or flaws in the sidewall. At least substantially uniform illumination of the illumination region may facilitate the detection of nontransparent defects, such as inclusions. At least substantially uniform illumination of the illumination region may facilitate detection of stress flaws or stress defects in the sidewall. The second illumination pattern may correspond to an illumination of different sub-regions of the illumination region with different light intensities. In particular, sub-regions with different light intensities may alternate spatially. When illuminating with the second illumination pattern, certain sub-regions of the illumination region may be illuminated with a first, higher intensity and certain other sub-regions of the illumination region may simultaneously be illuminated with a second, lower light intensity. The second illumination pattern may be richer in contrast than the first illumination pattern. Illuminating different parts of the illumination region with different light intensities may make it easier to detect transparent flaws or defects in the sidewall, for example those that have fluctuating wall thicknesses but little or no contrast-generating properties. The second illumination pattern may, for example, make it easier to detect thin spots or flat bubbles in the sidewall.

The illumination device may be configured to illuminate the illumination region in a stripe pattern when illuminating the illumination region with the second illumination pattern. In the stripe pattern, stripes of lower light intensity may alternate with stripes of higher light intensity. For example, at least 10, or at least 15, or at least 20, or at least 25, or at least 30 stripes may be provided. The stripes may run parallel to each other. The stripes may be adapted as horizontal stripes. The stripes may be adapted as vertical stripes. The stripe pattern may make it easier to detect transparent flaws or defects in the sidewall.

The illumination device may be configured to illuminate the illumination region in a checkered pattern or chessboard pattern when illuminating the illumination region with the second illumination pattern. In the checkered pattern or chessboard pattern, fields of lower light intensity may alternate with fields of higher light intensity. A checkered pattern or chessboard pattern may achieve a particularly high-contrast illumination of the illumination region, which may make it easier to detect transparent flaws or defects in the sidewall.

The first illumination pattern may be configured to make a first type of defect in the sidewall recognizable. The second illumination pattern may be configured to make a second type of defect in the sidewall recognizable. The first illumination pattern may be configured to facilitate detection of a first type of defect in the sidewall. The second illumination pattern may be configured to facilitate detection of a second type of defect in the sidewall. The first type of defects may comprise, for example, opaque defects and/or stress defects. The second type of defects may comprise, for example, transparent defects.

The apparatus may comprise a computing unit. The computing unit may be configured to compose the photos captured during rotation of the container in the first time windows into a first image. The computing unit may be configured to compose the photos captured during rotation of the container in the second time windows into a second image. In each case, the composed image may depict a region of the sidewall of the container that extends around a full circumference of the sidewall. The composed image may represent a sort of unrolled view of the region of the sidewall. The composed images may facilitate analysis of the photos to detect defects or flaws in the sidewall.

The computing unit may be configured to analyze the composed images to detect flaws or defects in the sidewall, in particular using an image analysis algorithm.

The illumination device may comprise light sources. The illumination device may comprise a plurality of light sources, for example at least 50 light sources, or at least 100 light sources, or at least 500 light sources, or at least 1000 light sources, or at least 1250 light sources. In particular, the illumination device may have, for example, 1218 light sources. The light sources may be adapted as LEDs, for example. The light sources may be identical light sources. The light sources may be configured to illuminate the illumination region with light in the visible wavelength range. The LEDs may be configured to illuminate the illumination region with NIR light (near-infrared light). The NIR light may, for example, have wavelengths in the range between 760 nanometers and 2500 nanometers. The use of NIR light may be particularly advantageous when examining black glass.

The illumination device may comprise a polarization filter. The illumination device may be configured to illuminate the illumination region through the polarization filter. The polarization filter may be a linear polarization filter. The polarization filter may be configured to pass light of a determining linear polarization, in particular to pass only light of the determining linear polarization. Illumination by a polarization filter may facilitate the detection of stress flaws defects or stress defects in the sidewall.

The illumination device may comprise light sources which are involved both in illuminating the illumination region with the first illumination pattern in the first time windows and in illuminating the illumination region with the second illumination pattern in the second time windows. The use of light sources for both the first illumination pattern and the second illumination pattern may reduce the total number of light sources required.

The illumination device may be configured to periodically change a brightness of at least one light source of the illumination device. By periodically changing the brightness of the at least one light source, a change between the first illumination pattern and the second illumination pattern may be achieved.

Changing the brightness of the at least one light source may occur by means of controlling the current. Changing the brightness of the at least one light source may occur by means of voltage regulation. Changing the brightness of the at least one light source may occur by means of pulse width modulation. By controlling the at least one light source by means of pulse width modulation, a particularly high-frequency brightness change may be achieved, in particular compared to switching selected light sources off and on completely. The pulse width modulation may extend over the entire duration of the first illumination pattern and over the entire duration of the second illumination pattern in order to avoid creating dark spots over time.

The illumination unit may be configured in such a way that each light source emits a constant luminous flux over the entire duration of the first illumination pattern, i.e. has a constant brightness over time. The lighting unit may be configured in such a way that each light source emits a constant luminous flux over the entire duration of the second illumination pattern, i.e. has a constant brightness over time.

The illumination device may comprise several groups of light sources. The illumination device may be configured to control the light sources of all groups of light sources to emit the same luminous flux when illuminating the illumination region with the first illumination pattern. The illumination device may be configured to control the light sources of certain groups of light sources to emit a different luminous flux than the light sources of certain other groups of light sources when illuminating the illumination region with the second illumination pattern. The groups of light sources may each correspond to a strip of an illumination pattern with which the illumination region is illuminated when illuminated with the second illumination pattern.

The illumination device may comprise an array of light sources. The light sources may be arranged in a plane. Preferably, a distance between adjacent light sources is not more than 10 millimeters, or not more than 7 millimeters, or not more than 5 millimeters, or not more than 4.5 millimeters.

The first time windows and the second time windows may alternate with a frequency of at least 10 kilohertz, or of at least 15 kilohertz, or at least 20 kilohertz, or at least 25 kilohertz, or at least 30 kilohertz, or at least 35 kilohertz, or at least 40 kilohertz, or at least 45 kilohertz, or at least 50 kilohertz.

The different illumination patterns may alternate with a frequency of at least 15 kilohertz, or at least 20 kilohertz, or at least 25 kilohertz, or at least 30 kilohertz, or at least 35 kilohertz, or at least 40 kilohertz, or at least 45 kilohertz, or at least 50 kilohertz.

The capturing device may comprise a first capturing unit. The first capturing unit may be configured to take a photo of the illumination region in every first time window. The first capturing unit may further be configured to take a photo of the illumination region in every second time window. The first capturing unit may be configured to take at least one photo of the illumination region during each alternating illumination of the illumination region with the different illumination patterns. The first capturing unit may be adapted without a polarization filter, i.e. configured to capture light from the capturing region without passing through a polarization filter.

According to an embodiment, the first capturing unit may be provided as the only capturing unit of the capturing device. Alternatively, the capturing device may comprise one or more further capturing units. In particular, the capturing device may comprise a second capturing unit.

The second capturing unit may be configured to take a photo of the illumination region in each first time window. The second capturing unit may comprise a polarization filter. The second capturing unit may be configured to take a photo of the illumination region through the polarization filter in each first time window. The polarization filter may be a linear polarization filter. The polarization filter may be rotated 90 degrees with respect to a polarizing filter of the illumination device. The resulting image may be almost black due to the crossed polarizing filters. Stress-generating defects in the sidewall that rotate the polarization plane of the light may be brightly visible in the image.

The first capturing unit and the second capturing unit may each capture the illumination region through an optical system. The first capturing unit and the second capturing unit may capture the illumination region through the same optics, i.e. share the optics. The optics may be adapted as telecentric optics.

If the first capturing unit and the second capturing unit are provided, two photos may be generated in each first time window, one by the first capturing unit and one by the second capturing unit. Due to different properties of the first capturing unit and the second capturing unit, different photos may be obtained in which different types of flaws or defects of the sidewall are visible. For example, opaque defects or flaws may be particularly visible in photos captured by the first capturing unit without a polarizing filter. In photos captured by the second capturing unit with a polarization filter, stress-based defects or flaws may be particularly visible.

A third capturing unit could also be provided, which is configured to take a photo of the illumination region in every second time window. If a third capturing unit is provided, it is possible, but not mandatory, that the first capturing unit also takes a photo of the illumination region in every second time window.

The terms “first capturing unit”, “second capturing unit”, and “third capturing unit” are used for ease of reference to the capturing units, but are not limiting. For example, the presence of the third capturing unit does not necessarily require that a second capturing unit is also present. In particular, only the first capturing unit could be provided, or only the first capturing unit and the second capturing unit could be provided, or only the first capturing unit and the third capturing unit could be provided, or the first capturing unit, the second capturing unit and the third capturing unit could be provided.

The first capturing unit, the second capturing unit and/or the third capturing unit may be adapted as a camera, in particular as a line scan camera or as a matrix camera.

The first capturing unit, the second capturing unit and/or the third capturing unit may be adapted to capture black glass.

The illumination device and the capturing device may be provided on opposite sides of the illumination region. The illumination region may lie between the illumination device and the capturing device. The container may be rotated about the axis of the container between the illumination device and the capturing device. The capturing device may be configured to capture the photos using the transmitted light method.

The apparatus may comprise a transport device for transporting the containers along a transport direction. The transport device may be configured to transport the containers to the illumination region and to remove the containers from the illumination region after the containers have been inspected. The transport device may be configured to move the containers along a circular path. The transport device may be adapted as a star wheel. The transport device may be configured to move the containers along a linear transport path.

The illumination device, the rotation device and the capturing device may together form an inspection station. The inspection station may be referred to as the first inspection station. As described, the first inspection station may be adapted to inspect the section of the sidewall of the container passing through the illumination region. The apparatus may comprise at least one further inspection station, in particular a second inspection station, which may also have an illumination device, a rotation device and a capturing device. The container may be inspected successively in the inspection stations. The second inspection station may be adapted analogously to the first inspection station, except for a different position of the illumination region in relation to the container. In the second inspection station, a different section of the sidewall of the container may pass through an illumination region and be inspected. In this way, a larger section of the sidewall or preferably the entire sidewall may be inspected by arranging several inspection stations in succession.

According to a further aspect of the invention, a method for inspecting containers is provided. A container having a bottom and having a sidewall is rotated about an axis of the container so that at least a section of the sidewall passes through an illumination region along a rotational direction. The illumination region is alternately illuminated with different illumination patterns. The different illumination patterns comprise at least a first illumination pattern and a second illumination pattern. The illumination region is illuminated with the first illumination pattern in first time windows and with the second illumination pattern in second time windows. A photo of the illumination region is taken at least in each first time window and in each second time window.

Depending on the illumination pattern with which the sidewall is illuminated in the illumination region, different types of flaws or defects in the sidewall may be visible to different degrees. In the first time windows, in which the illumination region is illuminated with the first illumination pattern, a different type of flaw or defect in a region of the sidewall located in the illumination region may be particularly well recognizable than in the second time windows, in which the illumination region is illuminated with the second illumination pattern.

The first illumination pattern may correspond to an at least substantially uniform illumination of the illumination region. An at least substantially uniform illumination of the illumination region may facilitate the detection of opaque defects or flaws in the sidewall. At least substantially uniform illumination of the illumination region may facilitate the detection of nontransparent defects, such as inclusions. At least substantially uniform illumination of the illumination region may facilitate detection of stress flaws or stress defects in the sidewall. The second illumination pattern may correspond to an illumination of different sub-regions of the illumination region with different light intensities. In particular, sub-regions with different light intensities may alternate spatially. When illuminating with the second illumination pattern, certain sub-regions of the illumination region may be illuminated with a first, higher intensity and certain other sub-regions of the illumination region may simultaneously be illuminated with a second, lower light intensity. The second illumination pattern may be richer in contrast than the first illumination pattern. Illuminating different parts of the illumination region with different light intensities may make it easier to detect transparent flaws or defects in the sidewall, for example those that have fluctuating wall thicknesses but little or no contrast-generating properties. The second illumination pattern may, for example, make it easier to detect thin spots or flat bubbles in the sidewall.

The photos captured in the first time window may be composed into a first image. The photos captured in the second time window may be composed into a second image.

In each first time window, a further photo of the illumination region may be captured, wherein the further photo is preferably captured through a polarization filter.

To switch from the first illumination pattern to the second illumination pattern, a plurality of light sources may be controlled by means of pulse width modulation so that the luminous flux emitted by the light sources is changed.

As described, the invention comprises an apparatus for inspecting containers and a method for inspecting containers. Features, explanations and descriptions described in relation to the apparatus may be transferred to the method. Features, explanations and descriptions described in relation to the method may be transferred to the apparatus. The apparatus may be suitable, adapted and/or configured to perform the method. The method may be carried out using the apparatus or may be able to be carried out using the apparatus. The method step of rotating the container may occur by means of the rotation device described in relation to the apparatus. The method step of illuminating the illumination region may occur by means of the illumination device described in relation to the apparatus. The method step of taking a photo of the illumination region in each first time window and in each second time window may occur by the capturing device described in relation to the apparatus.

### BRIEF DESCRIPTION OF THE DRAWINGS

In the following, the invention will be described further by means of embodiments with reference to the figures.

FIG. 1 shows a schematic top view of an apparatus for inspecting containers according to an embodiment.

FIG. 2A shows a schematic partial side view of the apparatus in the direction of view from the illumination device of the first inspection station to a container inspected in the first inspection station according to the embodiment.

FIG. 2B shows a schematic partial side view of the apparatus in the direction of view from the illumination device of the second inspection station to a container inspected in the second inspection station according to the embodiment.

FIG. 3A shows a schematic partial sectional view through the apparatus in the region of the first inspection station according to the embodiment, wherein the sectional plane is a vertical plane which is parallel to a radial direction with respect to the star wheel.

FIG. 3B shows a schematic partial sectional view through the apparatus in the region of the second inspection station according to the embodiment, wherein the sectional plane is a vertical plane which is parallel to a radial direction with respect to the star wheel.

FIG. 4 shows a schematic view of the illumination device of an inspection station in the direction of view from a container inspected in the inspection station to the illumination device according to the embodiment.

FIG. 5 shows a schematic representation of the chronological sequence of the illumination regions according to an embodiment.

FIG. 6 shows a schematic representation of the process of inspecting the container with the apparatus according to an embodiment.

FIG. 7A shows a schematic representation of a first image composed of individual photos according to an embodiment.

FIG. 7B shows a schematic representation of a second image composed of individual photos according to an embodiment.

FIG. 7C shows a schematic representation of a third image composed of individual photos according to an embodiment.

FIG. 8 shows a schematic representation of an illumination device of the apparatus according to an embodiment.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

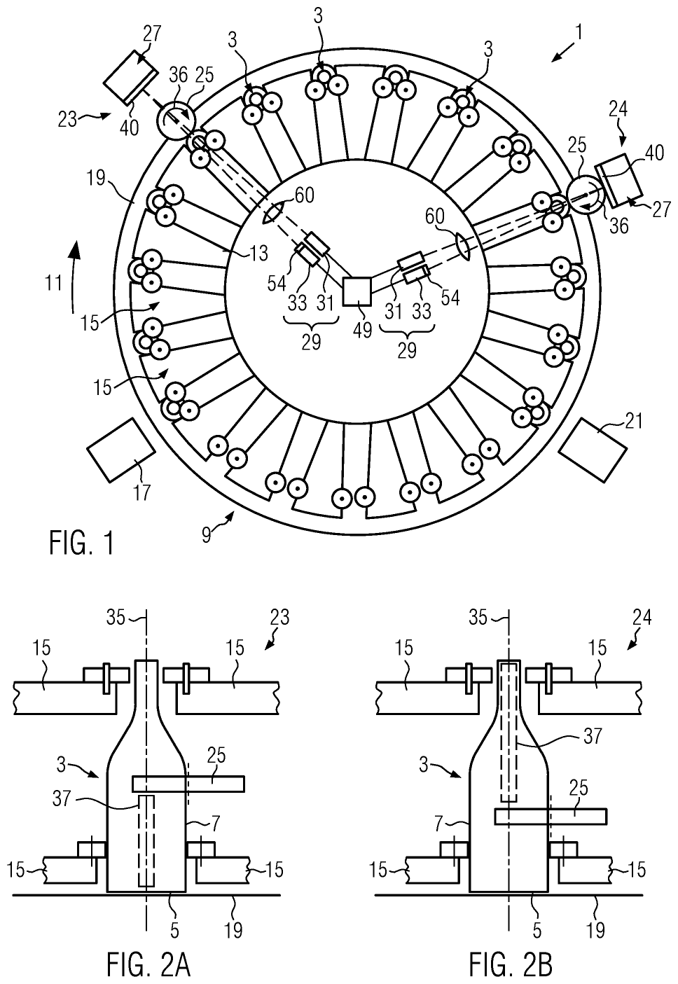

FIG. 1 shows a schematic top view of an apparatus 1 for inspecting containers 3 according to an embodiment. As shown in FIGS. 2A and 2B, the containers 3 are bottles with a bottom 5 and with a sidewall 7. Alternatively, the containers 3 may be jars or other types of packaging glass, for example.

As shown in FIG. 1, the apparatus 1 comprises a transport device 9 for transporting the containers 3 along a transport direction 11. In the embodiment shown, the transport device 9 has a star wheel 13, which transports the containers 3 along a circular path. The star wheel 13 comprises holding elements 15, which are arranged one behind the other along a circumferential direction of the star wheel 13. The containers 3 are transferred from a transfer station 17 to the star wheel 13 by placing them between adjacent holding elements 15 of the star wheel 13. By rotating the star wheel 13, the containers 3 are conveyed along the transport direction 11. During conveying, the containers 3 are pushed over a transport surface 19 of the transport device 9 by the holding elements 15 of the star wheel 13. The transport of the containers 3 along the transport direction 11 occurs in a clocked manner. After the containers 3 have been inspected in the apparatus 1, they are removed from the transport device 9 by a removal station 21 located downstream of the transfer station 17 with respect to the transport direction 11. A first inspection station 23 and a second inspection station 24 are provided successively with respect to the transport direction 11 between the transfer station 17 and the removal station 21, at which the sidewall 7 of the containers 3 is inspected for flaws or defects. During the inspection of a container 3 by the inspection stations 23, 24, the star wheel 13 is preferably stationary. Preferably, therefore, no transport of the container 3 along the transport direction 11 occurs during this time.

During the inspection of the container 3 in an inspection station 23, 24, the container 3 is in contact with a rotation device 25 of the inspection station 23, 24. In the embodiment shown, the rotation device 25 is in contact with the sidewall 7 to rotate the container 3. Alternatively, the rotation device 25 may be embedded in the transport surface 19 as a turntable and the container 3 may stand on the rotation device 25 while the container 3 is being inspected. The inspection stations 23, 24 each comprise an illumination device 27 and a capturing device 29. In the embodiment shown, the capturing device 29 comprises a first capturing unit 31 and a second capturing unit 33. FIG. 2A shows a schematic side view of a container 3 inspected by the first inspection station 23 as viewed from the illumination device 27 of the first inspection station 23 onto the container 3. During inspection, the container 3 is rotated about an axis 35 of the container 3 along a rotational direction 36 by the rotation device 25 of the first inspection station 23. In the embodiment shown, the axis 35 is a central axis of the container 3 perpendicular to the bottom 5 of the container 3. When the container 3 is rotated by the rotation device 25, the sidewall 7 of the container 3 passes through an illumination region 37 of the first inspection station 23 illuminated by the illumination device 27 of the first inspection station 23, which is shown dashed in FIG. 2A.

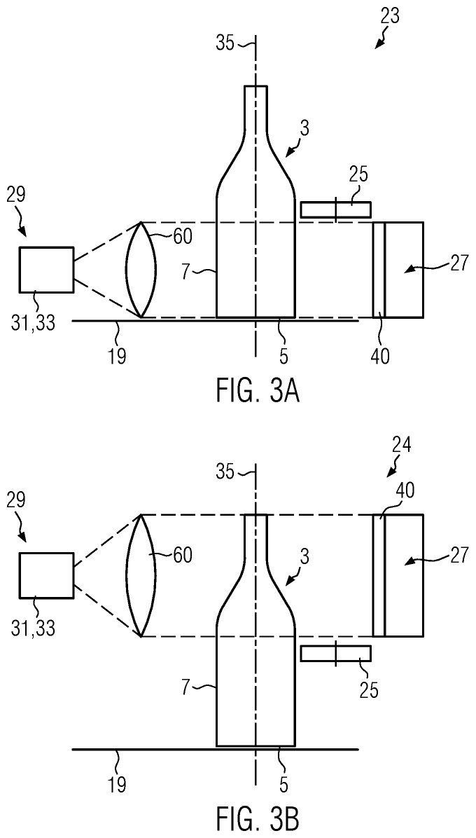

FIG. 3A shows a schematic sectional view in the region of the first inspection station 23, wherein the sectional plane is a vertical plane which is parallel to a radial direction with respect to the star wheel 13. In the embodiment shown, the illumination device 27 and the capturing device 29 are each provided on opposite sides of the inspected container 3, so that the capturing device 29 captures photos of the capturing region 37 when the capturing region 37 is illuminated by transmitted light. The capturing device 29 preferably captures the illumination region 37 through an optics 60. The first capturing unit 31 and the second capturing unit 33 of the capturing unit 29 may share the optics 60. The optics 60 may be adapted as telecentric optics

As may be seen from FIG. 3A, the rotation device 25 covers a partial region of the container 3, so that not the entire height of the container 3 may be illuminated by the illumination device 29 of the first inspection station 24. In the embodiment shown, the illumination region 37 illuminated by the illumination device 29 of the first inspection station 23 extends below the rotation device 25 of the first inspection station. The second inspection station 24 is provided so that the entire height of the sidewall 7 may still be inspected. FIG. 2B is a view of the second inspection station 24 analogous to FIG. 2A. FIG. 3B is a view of the second inspection station 24 analogous to FIG. 3A. As may be seen from FIG. 2B and FIG. 3B, the rotation device 25 of the second inspection station 24 is arranged lower than the rotation device 25 of the first inspection station 23. The capturing region 37 of the second inspection station 24, illuminated by the illumination device 27 of the second inspection station 24 and imaged by the capturing device 29 of the second inspection station 24, extends above the rotation device 25 of the second inspection station 24. When a container 3 is inspected successively in the first inspection station 23 and in the second inspection station 24, the sidewall 7 may be inspected over the entire height of the sidewall 7. The second inspection station 24 is adapted analogously to the first inspection station 23 except for the changed height position of the rotation device 25, the illumination device 27 and the capturing device 29 compared to the first inspection station 23. The function of the inspection stations 23, 24 is therefore described below together for both inspection stations 23, 24.

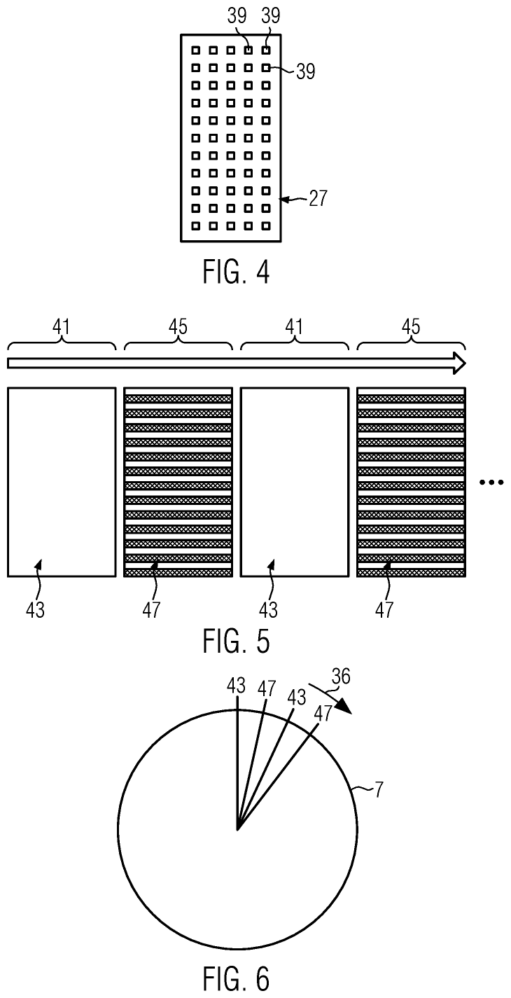

FIG. 4 shows a schematic representation of the illumination device 27 of one of the inspection stations 23, 24 in the viewing direction from the inspected container 3 to the inspection station 23, 24. The illumination device 27 comprises a plurality of light sources 39, which are arranged in horizontal rows in the embodiment shown. The light sources 39 may, for example, be adapted as LEDs. As shown in FIGS. 1, 3A and 3B, the illumination device 29 comprises a linear polarization filter 40 through which the illumination device 29 illuminates the illumination region 37.

While the sidewall 7 of the container 3 passes through the illumination region 37 along the rotational direction 36, the illumination pattern generated by the illumination device 27 in the illumination region 37 changes over time by alternately illuminating the illumination region 37 with two different illumination patterns. This may occur in the same manner for both inspection stations 23, 24. As shown schematically in FIG. 5, the illumination region 37 is alternately illuminated periodically over time in a first time window 41 with a first illumination pattern 43 and a second time window 45 with a second illumination pattern 47. First time windows 41, in which the illumination region 37 is illuminated with the first illumination pattern 43, and second time windows 45, in which the illumination region 37 is illuminated with the second illumination pattern 47, thus alternate periodically in time.

In the embodiment shown, the first illumination pattern 43 corresponds to an at least substantially homogeneous illumination of the illumination region 37. In the embodiment shown, the second illumination pattern 47 corresponds to an illumination of the illumination region 37 in which horizontal stripes of higher light intensity alternate with horizontal stripes of lower light intensity.

The first capturing unit 31 of the respective inspection station 23, 24 is configured to take a photo of the illumination region 37 in each first time window 41 and in each second time window 45. The photo depicts a region of the sidewall 7 of the container 3 present in the illumination region 37 at the time of the respective photo under the respective illumination (first illumination pattern 43 or second illumination pattern 47).

FIG. 6 schematically shows the distribution of the photos captured with the different illumination patterns 43, 47 in relation to the respective circumferential position of the sidewall 7 of the container 3 facing the first capturing unit 31 at the time of the photo. The radial lines in FIG. 5 represent circumferential positions of the sidewall 7 of the container 3 which were directly opposite the first capturing unit 31 in a corresponding photo. Lines characterized by the reference sign 43 symbolize a photo in which the illumination region 37 was illuminated with the first illumination pattern 43. Lines characterized by the reference sign 47 symbolize photos in which the illumination region 37 was illuminated with the second illumination pattern 47 during capturing the photo.

The apparatus 1 comprises a computing unit 49 shown schematically in FIG. 1. The computing unit 49 is configured to coordinate the capturing device 29 and the illumination device 27 of the respective inspection station 23, 24, in particular to synchronize them by means of a trigger signal. The computing unit 49 is also configured to compose images from the photos captured by the capturing devices 29. In FIG. 1, a common computing unit 49 is provided for both inspection stations 23, 24. Alternatively, each inspection station 23, 24 could comprise its own computing unit, each of which can, for example, communicate with a higher-level computing unit.

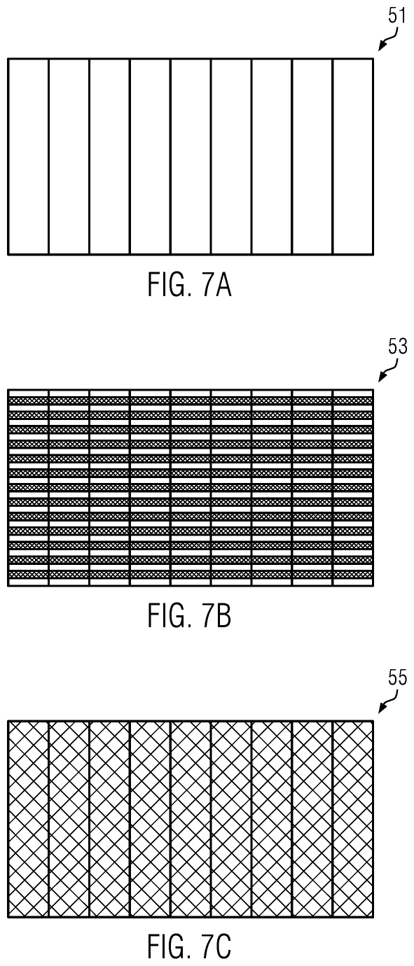

The photos captured during the inspection of a container 3 by the first capturing unit 31 in the first time periods 41, i.e. with the first illumination pattern 43, are composed to form a first image 51. The first image 51 is shown schematically in FIG. 7A. In the first image 51, opaque defects or flaws in the sidewall 7 may be recognizable.

The photos captured during the inspection of the container 3 by the first capturing unit 31 in the second time windows 45, i.e. with the second illumination pattern 47, are composed to form a second image 53. The second image 53 is shown schematically in FIG. 7B. In the second image 53, transparent flaws or defects in the sidewall 7 may be recognizable.

In the embodiment described, the second capturing unit 33 is configured to take a photo of the illumination region 37 in each first time window 41 while inspecting a container 3. The second capturing unit 33 comprises a polarization filter 54 (see FIG. 1), through which the second capturing unit 33 captures the illumination region 37. The polarization filter 54 may be a linear polarization filter. The polarization filter 54 may be rotated by 90 degrees relative to the polarization filter 40 of the illumination device 27. Due to the crossed polarization filters, the resulting image may almost black. Stress-generating defects in the sidewall 7, which rotate the polarization plane of the light, may be brightly visible in the image.

The images captured by the second capturing unit 33 while inspecting a container 3 during the first time windows 41, i.e. with the first illumination pattern 43, are composed to form a third image 55. The third image 55 is shown schematically in FIG. 7C. Since the images on which the third image 55 is based were captured through the polarization filter 54, the third image 55 differs from the first image 51. In the third image 55, stress defects in the sidewall 7 may be recognizable.

Preferably, a frequency of alternation between the first illumination pattern 43 and the second illumination pattern 47 is adjusted to the rotational speed of the container 3 and the width of the illumination region 37 in such a way that the first image 51, the second image 53 and the third image 55 each depict an entire circumference of the sidewall 7. The first image 51, the second image 53 and the third image 55 may be analyzed by the computing unit 49 or otherwise to detect defects or flaws in the sidewall 7. Since the first image 51, the second image 53 and the third image 55 are based on different illuminations, different types of defects may be recognized differently in the images.

A separate first image 51, second image 53 and third image 55 may be generated for each inspection station 23, 24, which represents the height range of the sidewall 7 imaged by the respective inspection station 23, 24. Alternatively, the data from the two inspection stations 23, 24 may be composed immediately, in particular by the computing unit 49, into a common first image 51, a common second image 53 and a common third image 55, which depicts the sidewall 7 over the entire height of the sidewall 7.

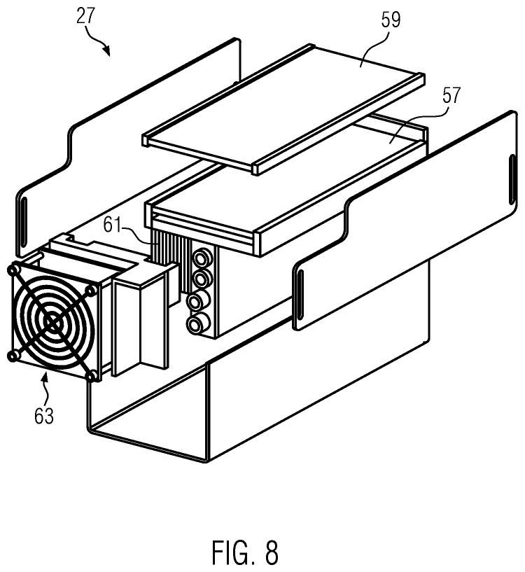

FIG. 8 shows a schematic exploded view of the illumination device 27. The illumination device 27 comprises a substrate plate 57 on which the light sources 39 are arranged. A transparent cover plate 59 is provided above the substrate plate 57 in order to protect the light sources 39 from dust. A heat sink 61 is provided below the substrate plate 57 to dissipate heat generated by the light sources 39. The heat sink 61 is cooled by means of a fan 63.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. Apparatus (1) for inspecting containers (3), comprising
an illumination device (27) configured to alternately illuminate an illumination region (37) with different illumination patterns comprising at least a first illumination pattern (43) and a second illumination pattern (47), wherein the illumination device (27) is configured to illuminate the illumination region (37) with the first illumination pattern (43) in first time windows (41) and to illuminate it with the second illumination pattern (47) in second time windows (45);
a rotation device (25) configured to rotate a container (3) having a bottom (5) and a sidewall (7) about an axis (35) of the container (3) in such a way that at least a portion of the sidewall (7) passes through the illumination region (37) along a rotational direction (36); and
a capturing device (29) configured to capture a photo of the illumination region (37) at least in each first time window (41) and in each second time window (45).

2. Apparatus according to claim 1, wherein the first illumination pattern (43) corresponds to an at least substantially uniform illumination of the illumination region (37) and the second illumination pattern (47) corresponds to an illumination of different sub-regions of the illumination region (37) with different light intensities.

3. Apparatus according to claim 1, wherein the illumination device (27) is configured, when illuminating the illumination region (37) with the second illumination pattern (47), to illuminate the illumination region (37) in a stripe pattern in which stripes of lower light intensity alternate with stripes of higher light intensity.

4. Apparatus according to claim 1, wherein the first illumination pattern (43) is configured to make a first type of defects in the sidewall (7) recognizable, and wherein the second illumination pattern (47) is configured to make a second type of defects in the sidewall (7) recognizable.

5. Apparatus according to claim 1, further comprising a computing unit (49) configured to compose the photos captured during the rotation of the container (3) in the first time windows (41) into a first image (51) and to compose the photos captured during the rotation of the container (3) in the second time windows (45) into a second image (53).

6. Apparatus according to claim 1, wherein the illumination device (27) comprises light sources (39) which are involved both in illuminating the illumination region (37) with the first illumination pattern (43) in the first time windows (41) and in illuminating the illumination region (37) with the second illumination pattern (47) in the second time windows (45).

7. Apparatus according to claim 1, wherein the illumination device (27) is configured to periodically change a brightness of at least one light source (39) of the illumination device (27), in particular by means of pulse width modulation.

8. Apparatus according to claim 1, wherein the illumination device (27) comprises a plurality of groups of light sources (39), wherein the illumination device (27) is configured to control the light sources (39) of all groups of light sources (39) to emit the same luminous flux when illuminating the illumination region (37) with the first illumination pattern (43), and to control the light sources (39) of certain groups of light sources (39) to emit a different luminous flux than the light sources (39) of certain other groups of light sources (39) when illuminating the illumination region (37) with the second illumination pattern (47).

9. Apparatus according to claim 1, wherein the illumination device (27) comprises an area array of light sources (39), wherein a distance of adjacent light sources (39) is not more than 10 millimeters.

10. Apparatus according to claim 1, wherein the first time windows (41) and the second time windows (45) alternate with a frequency of at least 10 kilohertz.

11. Apparatus according to claim 1, wherein the capturing device (29) comprises a first capturing unit (31) and a second capturing unit (33), wherein the second capturing unit (33) has a polarization filter (54), wherein the first capturing unit (31) is configured to take a photo of the illumination region (37) in each first time window (41), and wherein the second capturing unit (33) is configured to take a photo of the illumination region (37) in each first time window (41).

12. Method for inspecting containers (3), comprising:
rotating a container (3) having a bottom (5) and having a sidewall (7) about an axis (35) of the container (3) so that at least a portion of the sidewall (7) passes through an illumination region (37) along a rotational direction (36);
illuminating the illumination region (37) alternately with different illumination patterns comprising at least a first illumination pattern (43) and a second illumination pattern (47), wherein the illumination region (37) is illuminated with the first illumination pattern (43) in first time windows (41) and with the second illumination pattern (47) in second time windows (45); and
creating a photo of the illumination region (37) at least in each first time window (41) and in each second time window (45).

13. Method according to claim 12, wherein the photos captured in the first time windows (41) are composed into a first image (51), and the photos captured in the second time windows (45) are composed into a second image (53).

14. Method according to claim 12, wherein in each first time window (45) a further photo of the illumination region (37) is captured, wherein the further photo is preferably captured through a polarizing filter (54).
